(19) United States
(12) Patent Application Publication
(10) Pub. No.: US 2011/0071441 A1
(43) Pub. Date: Mar. 24, 2011

(54) ORTHOPEDIC REHABILITATION MECHANISM EMPLOYING A FOOT SUPPORT HAVING A FIRST PORTION AND A SECOND PORTION CONFIGURED TO ROTATE WITH RESPECT TO ONE ANOTHER

(76) Inventor: Darell E. Rodgers, Friendswood, TX (US)

(21) Appl. No.: 12/565,316

(22) Filed: Sep. 23, 2009

(51) Int. Cl. A61H 1/02

(52) U.S. Cl. 601/5

(57) ABSTRACT

Provided is an orthopedic therapy and rehabilitation device. The orthopedic device, in one embodiment, includes a foot support element configured to substantially support a user's foot or ankle, the foot support element having a first portion and a second portion that are configured to rotate with respect to one another about a pivot point. The orthopedic device may further include a plurality of guide lines each having a first and a second end, wherein each of the first ends are coupleable to the foot support element. The orthopedic device may even further include a control member coupleable to each of the second ends, the control member configured to control the plurality of guide lines to flex the user's foot or ankle in a plurality of directions.

### TECHNICAL FIELD

The present disclosure is directed, in general, to an orthopedic rehabilitation mechanism and, more specifically, to an orthopedic device for therapy and rehabilitation of joints to increase the range of motion of the joint, a method of manufacture therefor, and a method of operating the same.

### BACKGROUND

With improving technology and medical procedures, knee, hip, ankle and other orthopedic surgery has been greatly refined in the recent past, and is more widely available and performed every year. While surgical procedures and techniques have improved, post operative treatment typically includes prevention of unnecessary residual joint stiffness and focuses on achieving maximum functional range of motion as soon as possible.

In order to achieve optimal recovery, early assisted and active joint motion is generally encouraged. In the past, physical therapists, physicians, and clinical staff were often required to manually assist recovering patients in therapy movement of reconstructed joints and the like. Additionally, beforehand there has not been available a simple, safe, and reliable apparatus for encouraging and enabling early assisted and active joint motion by the patient.

Physical therapists have been known to use bed sheets tied around a patient's foot to induce ankle joint motion after surgery. Obviously, this is a time consuming, inefficient, and, at times, unsafe manner of accomplishing prompt rehabilitation of affected joints. As can be imagined, the unreliability of such makeshift therapy equipment tends to add to the cost of health care and discourages patients from continuing therapy on their own to improve their range of motion when not supervised by a professional therapist. The use of bed sheets and other previously available devices can also allow for uncontrolled movements, slippage, and the like which, in turn, can cause pain, injury, lack of confidence in the therapy, and less willingness to undertake such therapy.

Follow-up surgical repair work after ankle and other joint surgery are considered by some as a surgical complication, and risks associated with such postoperative surgery include anesthetic complications, wound dehiscence, infection, etc. While complications cannot be avoided in all instances, it is believed that most such complications occur in cases where assisted and active joint motion therapy was not aggressively undertaken. Consequently, a reliable and simple device which can be used by the patient to facilitate and increase postoperative flexion and range of motion exercise of affected joints is needed and has heretofore been unavailable in the industry. Additionally, while the above-described paragraphs discuss achieving maximum functional range of motion as soon as possible after a traumatic injury and ensuing surgery, equally important is achieving maximum functional range of motion for elder persons and diabetics.

Accordingly, what is needed is a simple, safe, and reliable orthopedic rehabilitation mechanism for therapy and rehabilitation of a joint which has undergone reconstruction, prosthesis implant, orthopedic surgery, degradation because of age or diabetes, or the like that does not have the drawbacks of the prior art devices.

### SUMMARY

One aspect provides an orthopedic therapy and rehabilitation device. The orthopedic device, in one embodiment, includes a foot support element configured to substantially support a user's foot or ankle, the foot support element having a first portion and a second portion that are configured to rotate with respect to one another about a pivot point. The orthopedic device may further include a plurality of guide lines each having a first and a second end, wherein each of the first ends are coupleable to the foot support element. The orthopedic device may even further include a control member coupleable to each of the second ends, the control member configured to control the plurality of guide lines to flex the user's foot or ankle in a plurality of directions.

Another aspect provides a method for operating an orthopedic therapy and rehabilitation device. The method, in one embodiment, may include 1) securing a foot or ankle to a foot support element, the foot support element having a first portion and a second portion that are configurable to rotate with respect to one another about a pivot point, the foot support element coupled to a control member, and 2) pulling different locations of the control member relative to the foot support element, the at least two guide lines causing the foot support element to flex the ankle or foot in a dorsi flexion direction, plantar flexion direction, inversion direction, eversion direction or any combination thereof.

### BRIEF DESCRIPTION

Reference is now made to the following descriptions taken in conjunction with the accompanying drawings, in which:

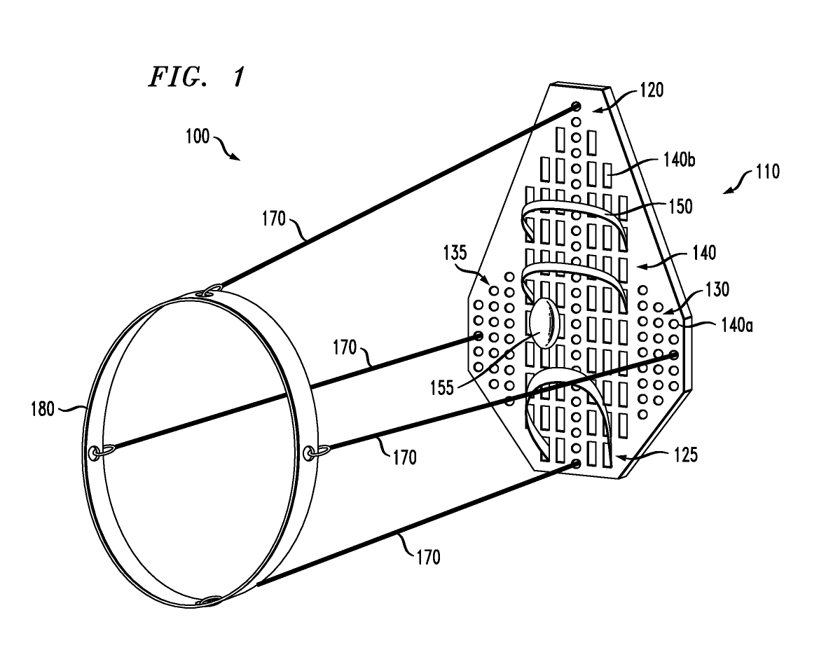

FIG. 1 illustrates a plan view of one embodiment of an orthopedic rehabilitation device;

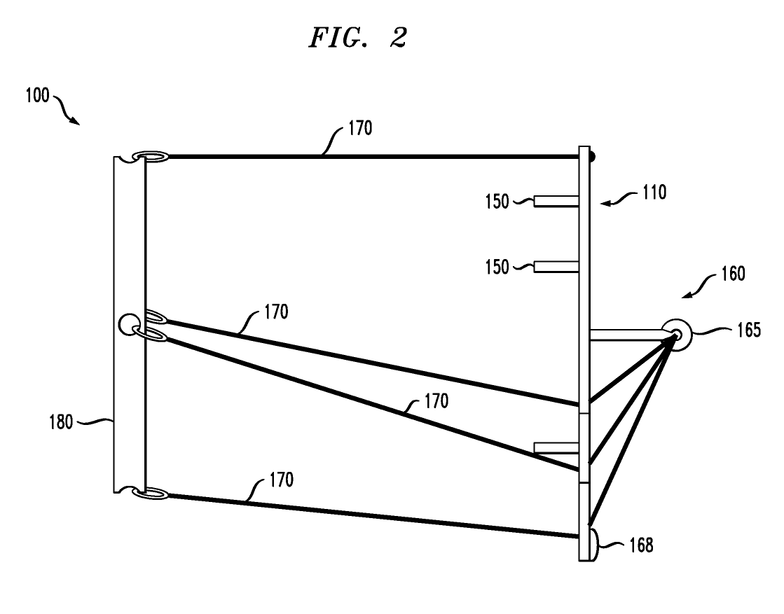

FIG. 2 illustrates a side view of the orthopedic rehabilitation device illustrated in FIG. 1;

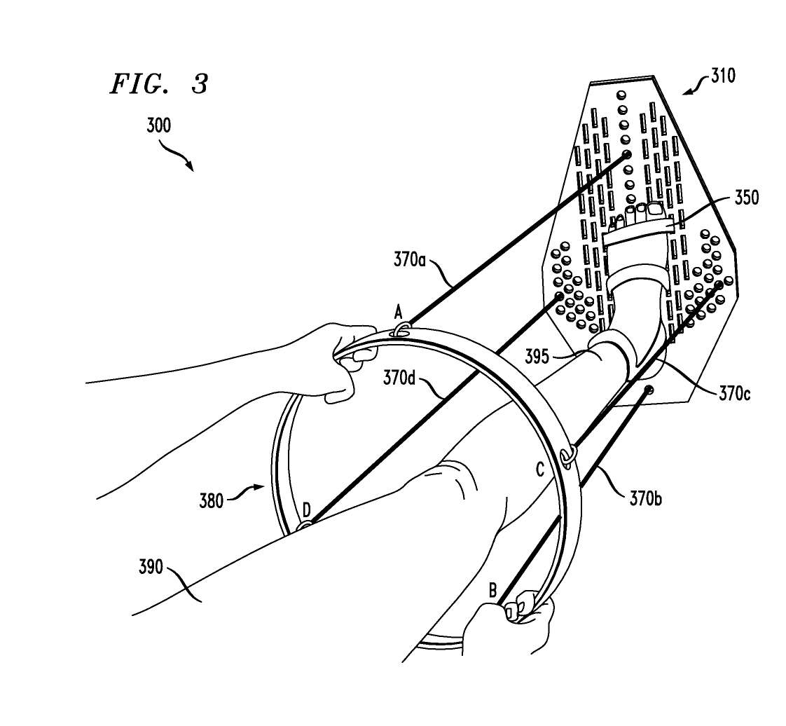

FIGS. 3 thru 4 illustrate schematic views of the use of an orthopedic rehabilitation device manufactured according to the principles of the present disclosure;

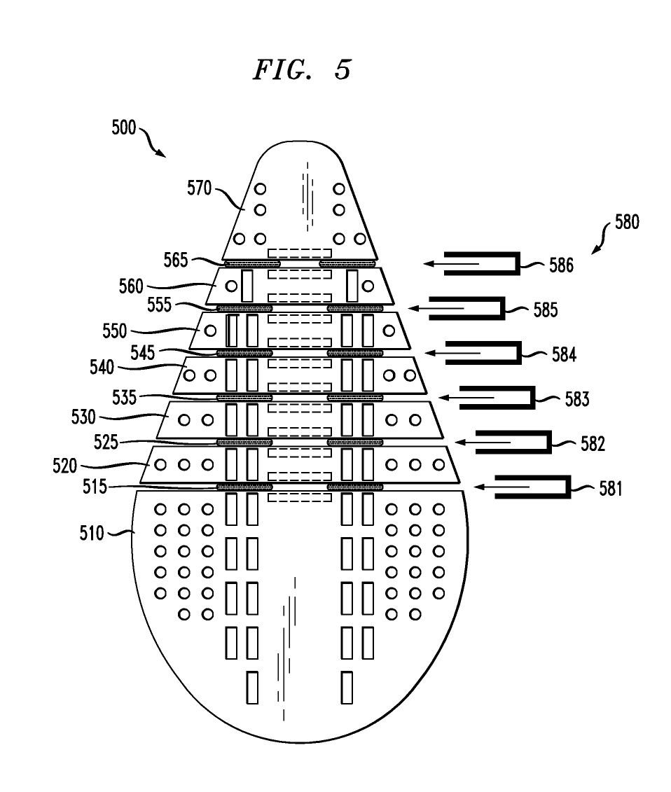

FIG. 5 illustrates an alternative embodiment of a foot support element;

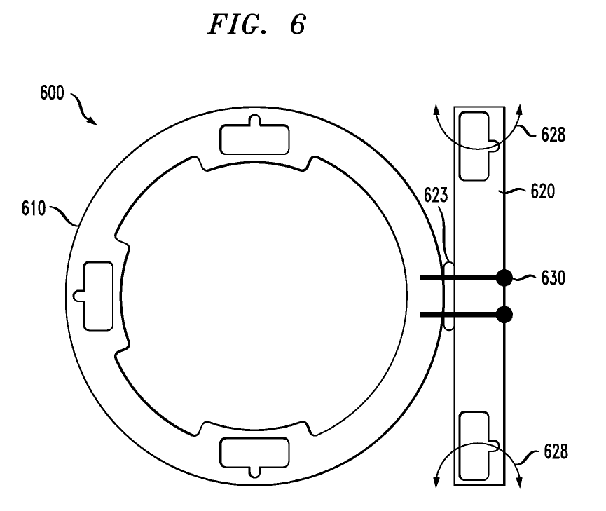

FIG. 6 illustrates an alternative embodiment of a control member;

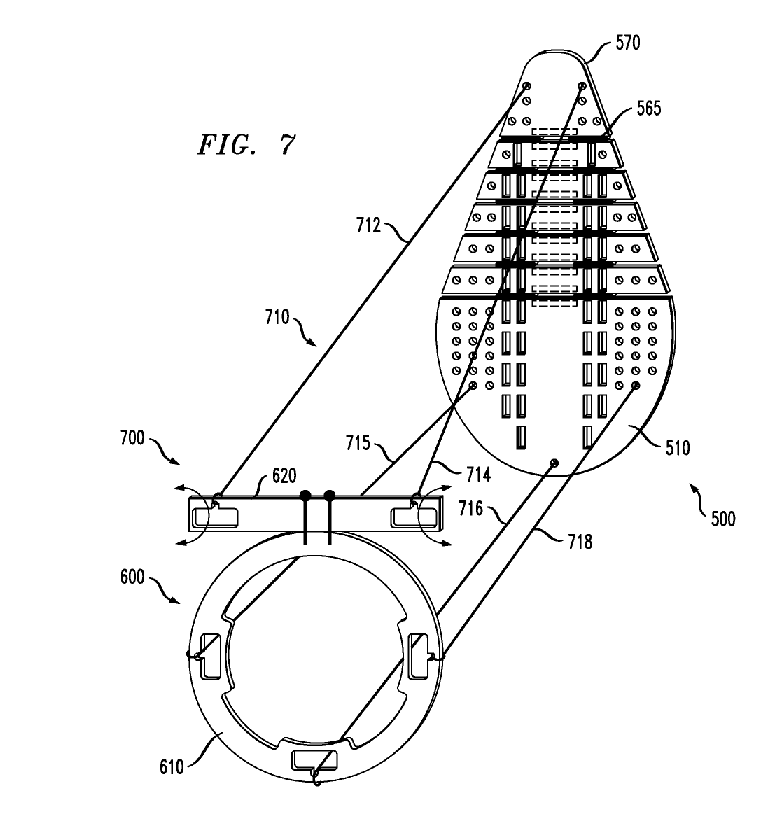

FIG. 7 illustrates a plan view of an alternative embodiment of an orthopedic rehabilitation device; and

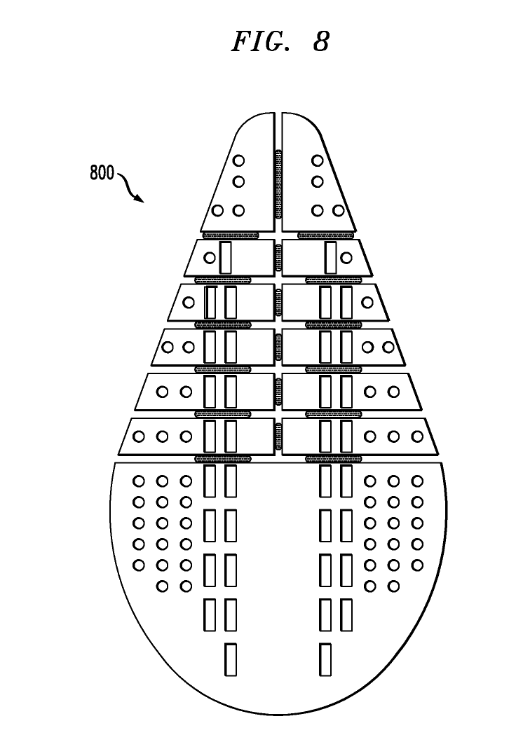

FIG. 8 illustrates yet another alternative embodiment of a foot support element.

### DETAILED DESCRIPTION

Referring initially to FIG. 1, illustrated is a plan view of one embodiment of an orthopedic rehabilitation device 100. The orthopedic rehabilitation device 100 illustrated in FIG. 1, among other purposes, is designed to rehabilitate the bones, muscles, tendons and ligaments associated with a number of different joints. In an exemplary embodiment of the disclosure, however, the orthopedic rehabilitation device 100 is advantageously configured to rehabilitate the bones, muscles, tendons and ligaments associated with the ankle. Therefore, the orthopedic rehabilitation device 100 functions as an Ankle Recovery Mechanism (The FASST System™).

The orthopedic rehabilitation device 100 illustrated in FIG. 1 initially includes a foot support element 110. The foot support element 110, as will be shown in subsequent figures, is designed to substantially support a user's foot or ankle. The foot support element 110 may comprise a number of different materials and shapes while remaining within the scope of the present disclosure. In one particular embodiment, the foot support element 110 comprises a substantially rigid material, such as hard plastic. Nevertheless, those skilled in the art understand that the foot support element 110 could comprise metal, resin, rubber, or any other substantially rigid material.

The foot support element 110, as dictated by its use, has a toe region 120, a heal region 125, an outer sole region 130 and an inner sole region 135. It should be noted that the depiction of which is the outer and inner sole region 130, 135, will vary depending on what foot, left or right, the device is affixed. In the current example, it is configured for the right foot. Depending on the shape of the foot support element 110, the aforementioned toe region 120, heal region 125, outer sole region 130 and inner sole region 135 may be interchanged. For instance, if the foot support element 110 were substantially square, a user's foot could be attached to the foot support element 110 in at least four different configurations. Nevertheless, in the embodiment of FIG. 1 the shape of the foot support element 110 is tapered, therefore the foot support element 110 may not accommodate different configurations as easily.

As is illustrated, the foot support element 110 includes a plurality of holes 140 located therein. The plurality of holes 140 have a number of different purposes. For instance, holes 140a are located proximate the toe region 120, heal region 125, outer sole region 130 and inner sole region 135 for accepting the guide lines 170. The plurality of holes 140a and their placement allow the positioning of the guide lines 170 to be tailored for a specific patient, or user. On the other hand, holes 140b are located proximate a position where the user's foot might be located. The holes 140b are configured to receive attachment means 150, such as support straps, to retain a user's foot or ankle within the foot support element 110. The plurality of holes 140b allow the attachment means 150 to be positioned to accommodate different size feet for the different user's that might use the orthopedic rehabilitation device 100.

Among other materials, the attachment means 150 may comprise any pliant or non-pliant material. In an exemplary embodiment of the disclosure a nylon strap having velcro on one or both ends would suffice as the attachment means 150. In an alternative embodiment, however, a stretchable bungy cord like material could be used as the attachment means 150. While only three attachment means are illustrated in FIG. 1, those skilled in the art appreciate that any combination of one or more attachments means 150 could be used.

Additionally, the attachment means 150 need not be a strap or a similar device. In certain embodiments it is envisioned where a boot is attached to or is the foot support element 110 for retaining the user's foot or ankle within the foot support element 110. The boot could be designed to fit a number of different foot sizes and could be coupled to the foot support element 110 using the aforementioned plurality of holes 140. Alternatively, the boot could be pre-fit to a given user's foot, thus being tailored to an individual user. As the pre-fit boot may be removably coupled to the foot support element 110, a number of different users having different pre-fit boots could each use the same orthopedic rehabilitation device 100.

In an exemplary embodiment, an arch support 155 is removably coupled to an upper surface of the foot support element 110. The arch support 155 is configured to provide support to an arch of the user during operation of the orthopedic rehabilitation device 100. As the arch support 155 is removably coupled to the foot support element 110, it can be removed if not needed, or positioned in a different location for a different user or foot. While illustrated, the arch support 155 is an option that may or may not be used.

Turning briefly to FIG. 2, illustrated is a side view of the orthopedic rehabilitation device 100 illustrated in FIG. 1. As is illustrated, a post portion 160 extends from a lower surface of the foot support element 110 in the embodiment of FIG. 2. The post portion 160 is configured to allow the user of the orthopedic rehabilitation device 100 to apply additional leverage to his or her foot or ankle during its use. In an exemplary embodiment the post portion 160 comprises a similar material as the foot support element 110, and contains a capping member 165 located on a distal surface thereof. The capping member 165 in the embodiment of FIG. 1 is designed to provide a connection point between the post portion 160 and the guide lines 170 (see below). It is also believed that the capping member 165 may allow the orthopedic rehabilitation device 100 to be operated on a slick surface, such as tile or wood, without a substantial concern that the post portion 160 would slip and further injure the user.

The post portion 160 may be movably coupled to the foot support element 110. For instance, the post portion 160 may be coupled to any one of the holes 140 of the foot support element 110. Depending on the desires of the user, the optimal position of the post portion 160 may change. These holes 140 further allow the position of the post portion 160 to be optimized. While it generally depends on the specific user, it is believed that the optimal position for the post portion 160 is centered on the user's foot.

In one advantageous embodiment, a number of the guide lines 170 extend through the holes 140a in the foot support element 110 and couple to the post portion 160 of the foot support element 110. While all of the guide lines 170 may couple to the post portion 160, the particular embodiment of FIG. 2 illustrates only the guide lines 170 that extend through the holes 140a of the heal region 125, outer sole region 130 and inner sole region 135 coupling to the post portion 160. Accordingly, the guide line 170 contacting the toe region 120 does not couple to the post portion 160. This configuration is designed to allow the user to further increase the aforementioned leverage.

Further located on a lower surface of the foot support element 110 in the embodiment of FIG. 2 is a sliding means 168. In the particular embodiment shown, the sliding means 168 is a tear shaped extension coupled to the heal region 125 of the foot support element 110. The sliding means 168, in one embodiment, is configured to allow the foot support element 110 to easily slide toward and away from the user when the heal region 125 of the foot support element 110 is resting on the floor and the user is working plantar and/or dorsi flexion.

The sliding means 168 may comprise a variety of different shapes and materials, if used, so long as it assists the heal region 125 of the foot support element 110 in sliding along the surface upon which it is being used. In one example, the sliding means 168 comprises a material providing very little friction, for instance hard plastic. Nevertheless, the prevent disclosure should not be limited so such. It should also be noted that the shape and location of the sliding means 168 may change. Above that shown in FIG. 2, it is envisioned where the sliding means 168 may extend from the lower surface of the foot support element 110 along the radial edge of the foot support element 110 and onto the upper surface of the foot support element 110. This embodiment would be useful for applications where the foot support element 110 is being used in a position substantially perpendicular to the floor.

Returning to FIG. 1, with continued reference to FIG. 2, the orthopedic rehabilitation device 100 further includes a control member 180. In the illustrative embodiment, the control member 180 has an opening therein and is configured to receive a user's leg therethrough. In the embodiment of FIG. 1 the control member 180 is a ring, or hoop, and is formed in the shape of a circle. Other shapes, including a triangle, square, or any three or more sided object could nevertheless be used. Additionally, the control member 180 need not form a closed circle. In an alternative embodiment, extension members could be coupled to the control member 180. The extension members might be configured in much the same way as a control member used to operate a child's puppet, for example in the shape of an X. Nevertheless, these extension members are not required.

In an alternative embodiment of the disclosure (not shown) the control member 180 does not receive the user's leg therethrough, and is just operated with the control member 180 proximate the user's mid-section or lap. While in this embodiment the control member 180 may still have an opening therein, such is not demanded as it does not need to accommodate the user's leg therethrough. Accordingly, the control member 180 of this embodiment may be a circular plate, a plate forming a polygon, a cross, a plus sign, or another similar shape while staying within the scope of the present disclosure.

Coupling the control member 180 to the foot support element 110 are at least two guide lines 170. While only two guide lines 170 are required, an exemplary embodiment has three or more guide lines 170 being used. For instance in the embodiment of FIG. 1 four guide lines 170 are being used. As is illustrated, a first end of each of the four guide lines 170 is coupled to the toe region 120, the heal region 125, the outer sole region 130 and the inner sole region 135, respectively, while the second end of each of the four guide lines 170 is coupled to various opposing locations of the control member 180.

In an exemplary embodiment the guide lines 170 comprise a rope like material. For instance, it is believed that the type of rope commonly used by rock climbers would work extremely well. Other materials, such as wire, chain, etc., could nonetheless be used for the guide lines 170. The length of the guide lines 170 may be adjusted depending on the height and comfortability of the user. Similarly, each of the at least two guide lines 170 need not be similar lengths. For example, depending on the height of the user, length of the leg of the user, and type and amount of Range Of Motion (ROM) that is desired, each of the at least two guide lines 170 may be individually either lengthened or shortened.

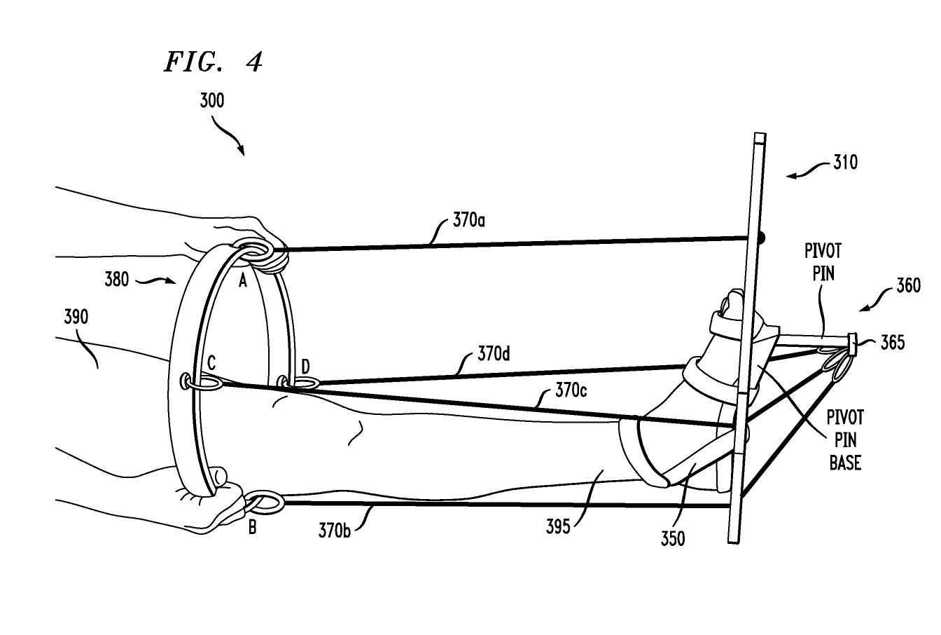

Turning now to FIGS. 3-4 illustrated are schematic views of the use of an orthopedic rehabilitation device 300 manufactured according to the principles of the present disclosure. In the embodiments illustrated in FIGS. 3-4, a user's leg 390, including the user's foot and ankle 395, is coupled to the orthopedic rehabilitation device 300 by way of the attachment means 350. While the embodiment illustrated in FIGS. 3-4 illustrates the user's left leg, left foot and ankle coupled to the orthopedic rehabilitation device 300, the orthopedic rehabilitation device 300 works equally as well for the right leg, foot and ankle.

The orthopedic rehabilitation device 300 is quite easy to use, however, it plays a huge impact in the rehabilitation of joints, and particularly the ankle joint. For example, by pulling point A of the control member 380 toward a torso of the user, the guide line 370a causes the foot support element to assist in dorsi flexion of the foot. In contrast, by pulling point B of the control member 380 toward a torso of the user, the guide line 370b causes the foot support element to assist in plantar flexion of the foot. Similarly, by pulling point C of the control member 380 toward a torso of the user, the guide line 370c causes the foot support element to assist in inversion of the foot. Lastly, by pulling point D of the control member 380 toward a torso of the user, the guide line 370d causes the foot support element to assist in eversion of the foot.

The embodiment discussed in the paragraph above assumes that a user's left leg is coupled to the foot support element 310. If the right leg, right foot and ankle were coupled to the foot support element 310 rather than the left leg as illustrated, guide line 370c would cause the foot support element 310 to assist in eversion of the foot. Similarly, if the right leg, right foot and ankle were coupled to the foot support element 310 rather than the left leg as illustrated, guide line 370d would cause the foot support element 310 to assist in inversion of the foot.

Those skilled in the art understand that the user could also pull a point in between say A and C (e.g., between any adjacent points) of the control member 380 toward a torso of the user, and the guide lines 370a and 370c would cause the foot support element 310 to simultaneously assist in both dorsi flexion and inversion (if using the left leg) of the foot. Accordingly, the orthopedic rehabilitation device 300 manufactured in accordance with the principles of the present disclosure can flex, and thus rehabilitate, the user's foot or ankle in a plurality of directions.

It should nonetheless be noted that while the embodiments of FIGS. 1-3 illustrate the control member having an opening therein configured to receive the user's leg, such is not always the case, as mentioned above. Similar, and possibly better flexibility may be attained by placing the control member in the user's lap during operation thereof. This method of operation may allow the user to apply even greater leverage to his or her foot or ankle during its use. Accordingly, as discussed above, the control member need not have an opening therein in all embodiments.

Normal mobility requires adequate tissue length and neuromuscular involvement. The structures involved in mobility and affected by the orthopedic rehabilitation device 100, without limitation, are joint articulation surfaces, joint capsule, tendons, ligaments, bursae, muscle, fascia, and skin. Normal motion is impaired when stiffening and/or shortening occur due to injury, adhesions, or immobilization. In order to regain normal motion, stretching of the stiff and/or short tissues must be done to increase ROM and/or guide healing tissues to proper length during the healing phases. While stretching and mobilizing stiff and/or shortened tissues has traditionally been restricted to manual therapy by a physical therapist, the orthopedic rehabilitation device 100 allows the patient to perform rigorous stretching in all pluralities of motion without the traditional hands-on physical therapy session. The orthopedic rehabilitation device 100 will stretch the affected tissues, which will stimulate fibrocytes to reestablish the tissue to the desired length. Elongation stimulates fibroblasts to lay collagen along the lines of stress produced by the manipulation of the orthopedic rehabilitation device, which will strengthen the tissue in the new lengthened position. Prevention of adhesions and contractures, decreased pain, evacuation of accumulated fluid, increased circulation, enhanced nutrition, decreased joint or tissue effusion, chondral repair, and early return of ROM are all associated benefits of stretching done with the orthopedic rehabilitation device 100. Further, not only will it benefit those having experienced a traumatic injury with or without an ensuing surgery, it is equally as applicable for elderly persons or diabetics with ROM problems. Additionally, it may be used for issues related to flat feet as well as simple or complex strains to the ligaments, tendons and muscles associated with the joints (e.g., patients afflicted by foot and ankle problems such as sprains, post-immobilization, and pes planus (flat feet); most of whom are diabetic and/or geriatric. These populations can all benefit from the use of an orthopedic rehabilitation device manufactured in accordance with this disclosure, with its unique ability to stretch the foot and ankle in all angles with precise control and force while limiting weight bearing activities.

Stretching is important for several reasons in all populations. Stretching often improves neuromuscular control, works the synovial fluid in the ankle joint, and stimulates muscles, tendons, and ligaments, which all promote a healthy foot and ankle. However, many patients are flat-footed, diabetic, and/or geriatric, which greatly reduce their ability to engage in weight bearing activities. Furthermore, many patients' injuries preclude their engaging in weight bearing activities. An orthopedic rehabilitation device manufactured in accordance with this disclosure is an ideal tool to address their limitations while maintaining the potential to maximize their therapy.

Additionally, sprains usually require gentle, precise stretching to heal optimally. However, this is usually achieved in the therapeutic setting but not achievable at home. An orthopedic rehabilitation device manufactured in accordance with this disclosure would allow patients to provide rehabilitation to these sprains while in formal therapy at a provider's office, as well as at home after formal rehabilitation is no longer justifiable or possible.

Post-immobilization of the foot/ankle is another significant problem. Surgery can repair the internal structures and immobilize patients until they have properly healed, but this leaves the patient stiff and with an ill-functioning foot/ankle. Therapy is traditionally used to assist these patients in obtaining functional range, but patients are not in therapy everyday and the rehabilitation process becomes prolonged. An orthopedic rehabilitation device manufactured in accordance with this disclosure could provide these patients the means of returning to functional range at a much faster pace due to therapy-at-home.

Flat-feet are another problem with great magnitude. Flat feet can be acquired due to tight plantar flexors, or what is referred to as the degenerative cascade of the foot, in which the foot gradually becomes more pronated. This affects many geriatric and diabetic patients, a population that continues to grow as baby boomers come of age. The use of an orthopedic rehabilitation device manufactured in accordance with this disclosure would dramatically assist this group of patients by providing them a safe, easy method to stretch their foot/ankle without causing additional problems.

FIG. 5 illustrates an alternative embodiment for a foot support element 500. The foot support element 500 of FIG. 5 includes many of the elements of the foot support element 110 illustrated in FIG. 1. However, the foot support element 500 further includes a first portion 510 and a second portion 520 that are configured to rotate with respect to one another about pivot points 515. In the disclosed embodiment, the first and second portions 510, 520 rotate with respect to one another along (e.g., about) a width of a users foot.

The foot support element 500 of FIG. 5 further includes a plurality of other portions that can rotate with respect to one another. For example, the foot support element 500 includes a third portion 530, a fourth portion 540, a fifth portion 550, a sixth portion 560 and a seventh portion 570, which are configured to rotate about second pivot points 525, third pivot points 535, fourth pivot points 545, fifth pivot point 555, and sixth pivot points 565, respectively. Accordingly, the foot support element 500 may have just about any number of portions that rotate with respect to one another and remain within the purview of the disclosure.

The foot support element 500 of FIG. 5 may further include one or more locking features 580. As is shown in the drawings, the locking features 580 may be used to lock any one (or all) of the first, second, third, fourth, fifth, sixth or seventh portions 510, 520, 530, 540, 550, 560, 570, respectively, with respect to one another. The locking features 580, in one embodiment, are rigid structures that are each configured to engage related pairs of portions of the foot support element 500. For example, if the first, second, third, fourth, and fifth locking features 581, 582, 583, 584, and 585, respectively, were engaged with the foot support element 500, and thus the sixth locking feature 586 was not, the foot support element would only rotate at the pivot points between the sixth portion 560 and seventh portion 570. Obviously, different combinations of locking features 580 could be employed to tailor where exactly the foot support element 500 would rotate. In many uses, the locking features 580 will be configured such that the foot support element 500 only has two planes that rotate with respect to one another. In certain uses, however, each of the locking features 581, 582, 583, 584, 585 and 586 could be employed to create a substantially rigid foot support element 500, for example where the foot support element 500 has no planes that rotate with respect to one another. In the embodiment of FIG. 5 the locking features 580 are cleats, but other rigid structures (such as a pin, bolt, etc.) may be used and remain within the purview of the disclosure.

FIG. 6 illustrates an alternative embodiment of a control member 600. The control member 600 of FIG. 6 includes a ring portion 610, as well as an individually rotatable portion 620. The ring portion 610, as those would skilled in the art can expect, may have an opening therein configured to receive a user's leg therethrough. The individually rotatable portion 620, in one intended use, may be rigidly held in relation to the ring portion 610. Accordingly, when the ring portion 610 is moved in an intended manner, the individually rotatable portion 620 would move in a related manner. However, in another intended use, the individually rotatable portion 620 may be rotatably released from the ring portion 610, and thus the individually rotatable portion 620 may rotate about point 623 in a manner independent from the ring portion 610. In this intended use, the individually rotatable portion 620 may rotate in a manner, such as shown by the arrows 628. In the embodiment of FIG. 6, the individually rotatable portion 620 may be rotatably released from the ring portion 610 by removing the pins 630. Any one of a number of mechanisms may be used to rotatably release/fix the individually rotatable portion 620 to the ring portion 610, including the pins 630 shown.

FIG. 7 illustrates an alternative embodiment of an orthopedic therapy device 700 constructed in accordance with this disclosure. The device 700 of FIG. 7 includes the foot support element 500 of FIG. 5 as well as the control member 600 of FIG. 6. In this embodiment, a plurality of guide lines 710 couple the foot support element 500 to the control member 600. In the embodiment shown, first ends of guide lines 712 and 714 attach to the seventh portion 570 of foot support element 500 and the second ends of the guide lines 712 and 714 attach to the individually rotatable portion 620. Likewise, the first ends of the guidelines 715, 716, and 718 attach to the first portion 510 of the foot support element 500 and the second ends of the guide lines 715, 716 and 718 attach to the ring portion 610. Accordingly, in this embodiment, the individually rotatable portion 620 may be rotatably released from the ring portion 610 (e.g., by removing the pins), and when the individually rotatable portion 620 is rotated relative to the ring portion 610, the seventh portion 570 will rotate about the sixth pivot points 565 relative to the first, second, third, fourth, fifth and sixth portions 510, 520, 530, 540, 550, and 560. Clearly, if the locking features 580 were to be reconfigured, the individually rotatable portion 620 could be used to rotate other foot support element portions with respect to one another. The location of the rotation within the foot support element 500 is highly dependent on the physical nature of the user, needs of the user, etc.

FIG. 8 illustrates an alternative embodiment of a foot support element 800. The foot support element 800 illustrates one embodiment wherein the first and second portions rotate along (e.g., about) a length of the user's foot. Likewise, there may be certain potential benefits from a situation wherein the rotation is both along a width of the user's foot as well as along a length of the user's foot, as might be possible with a foot support element similar to the foot support element 800.

Although the present disclosure has been described in detail, those skilled in the art should understand that they can make various changes, substitutions and alterations herein without departing from the disclosure.

What is claimed is:

1. An orthopedic therapy and rehabilitation device, comprising:
a foot support element configured to substantially support a user's foot or ankle, the foot support element having a first portion and a second portion that are configured to rotate with respect to one another about a pivot point;
a plurality of guide lines each having a first and a second end, wherein each of the first ends are coupleable to the foot support element; and
a control member coupleable to each of the second ends, the control member configured to control the plurality of guide lines to flex the user's foot or ankle in a plurality of directions.

2. The orthopedic device as recited in claim 1 wherein the control member has an opening therein configured to receive a user's leg therethrough.

3. The orthopedic device as recited in claim 2 wherein the control member has an individually rotatable portion, wherein ones of the first ends are coupleable to the first portion of the foot support element and related ones of the second ends are coupleable to the individually rotatable portion of the control member.

4. The orthopedic device as recited in claim 3 wherein the individually rotatable portion is configured to rotate the first portion relative to the second portion.

5. The orthopedic device as recited in claim 1 wherein ones of the first ends are coupleable to the first portion of the foot support element and related ones of the second ends are coupleable to the control member, the control member configured to rotate the first portion relative to the second portion.

6. The orthopedic device as recited in claim 1, further including a locking feature configured to substantially prevent the rotation of the first portion and the second portion with respect to one another.

7. The orthopedic device as recited in claim 6, wherein the locking feature is a rigid structure configured to engage both the first portion and the second portion to substantially prevent the rotation of the first portion and the second portion with respect to one another.

8. The orthopedic device as recited in claim 7 wherein the rigid structure is a cleat or pin.

9. The orthopedic device as recited in claim 1 wherein the foot support element has from two to seven portions configured to rotate with respect to one another about pivot point pins.

10. The orthopedic device as recited in claim 9 wherein the two to seven portions of the foot support element are lockable such that the foot support element has only two planes that rotate with respect to one another.

11. The orthopedic device as recited in claim 1 wherein the rotation is configured to be along a width of the user's foot.

12. The orthopedic device as recited in claim 1 wherein the foot support element has a post portion extending from a lower surface thereof.

13. The orthopedic device as recited in claim 12 wherein each of the first ends extend through an opening in the foot support element and attach to the post portion.

14. The orthopedic device as recited in claim 12 wherein the post portion is movably coupled to the lower surface of the foot support element for adjustment thereto.

15. The orthopedic device as recited in claim 1 further including an arch support coupled to an upper surface of the foot support element.

16. The orthopedic device as recited in claim 1 wherein the foot support element is a boot, the at least two guidelines coupleable to the boot.

17. A method for operating an orthopedic device for therapy and rehabilitation, comprising:
securing a foot or ankle to a foot support element, the foot support element having a first portion and a second portion that are configurable to rotate with respect to one another about a pivot point, the foot support element coupled to a control member; and
pulling different locations of the control member relative to the foot support element, the at least two guide lines causing the foot support element to flex the ankle or foot in a dorsi flexion direction, plantar flexion direction, inversion direction, eversion direction or any combination thereof.

18. The method as recited in claim 17 wherein pulling different locations of the control member causes the first portion and second potion to rotate with respect to one another.

19. The method as recited in claim 18 wherein pulling different locations of the control member causes the first portion and second potion to rotate with respect to one another along a width of the foot.

20. The method as recited in claim 17 wherein the control member has a individually rotatable portion, the individually rotatable portion configured to rotate the first portion and second portion relative to one another when pulled upon.
